(19) United States
(12) Patent Application Publication
(10) Pub. No.: US 2021/0374851 A1
(43) Pub. Date: Dec. 2, 2021

(54) Hierarchical Node-Based Display Architecture

(71) Applicant: TD Ameritrade IP Company, Inc., Omaha, NE (US)

(72) Inventors: Nafiseh SABERIAN, Ann Arbor, MI (US); Ravindra Reddy TAPPETA VENKATA, Novi, MI (US); Abhilash Krishnankutty NAIR, Ann Arbor, MI (US)

(21) Appl. No.: 16/886,144

(22) Filed: May 28, 2020

(51) Int. Cl. G06Q 40/04; G06Q 40/06; G06F 16/28; G06K 9/62

(52) U.S. Cl. CPC G06Q 40/04; G06Q 40/06; G06K 9/623; G06F 16/288; G06F 16/287

(57) ABSTRACT

An equity system receives input from multiple data subsystem module. The data is filtered and weighted. The filtered and weighted data is received by a visualization subsystem that generates a visual representation of the weighted, filtered data. The visualization is rendered to a user and may be a cluster web. The visualization includes connections defining the relatedness of the nodes in the visualization. A client device is configured to view the displayed visualized representation to a user, wherein the client device is configured to receive input from a user requesting execution of one of a trade or research based upon the displayed visualized representation.

### FIELD

The present disclosure relates to systems and methods for a user interface and, more particularly, to a user interface providing visual representations between selected entities based on information that addresses interrelationships between the selected entities.

### BACKGROUND

In the financial services industry, advisors and clients may be presented with an extensive amount of data that impacts a particular asset or an entire portfolio. Typically, such data and the relationships between the data and the particular asset or portfolio is presented in tables or graphs that present challenges to making associations between the data and the instrument or portfolio. Further, the aggregation of data presents more associations between the aggregated data and the asset, further complicating making logical decisions based on the associations.

Advisors and clients are typically busy and have limited time. Deciding on particular trades of assets or the composition of a portfolio can be very time consuming given the current data presentation approaches. Advisors and clients find themselves wanting to initiate transactions or structure their portfolios, but can be overwhelmed by the multiple associations with no tools to facilitate the decision making process. Further, an association between two securities can be dependent upon numerous factors, and the numerous factors further complicate the relationship between the two securities and the relationship between other securities related to the two securities. Present systems do not facilitate efficiently selecting the purchase or sale of instruments based on the available data.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system including an input subsystem module, and the input subsystem module is configured to receive and store data related to a first entity and entities related to the first entity, the input subsystem module generating relationship data. The system also includes a filter subsystem module, and the filter subsystem module is configured to process the relationship data. The filter subsystem module is also configured to remove data from the relationship data that is less relevant to a relationship between a pair of entities. The filter subsystem module generates filtered data. A weighting subsystem module is configured to receive the filtered data and apply weights to relationships between the entities, the weighting subsystem module generating weighted data. A visualization subsystem module is configured to receive the weighted data and generate a visualized representation of the related entities and the relationship between the entities. A server is configured to receive the visualized representation and generate a displayed visualized representation, the displayed visualized representation including the first entity and the related entities and the relationship therebetween, wherein the relationship is displayed by connections between the entities. A client device is configured to view the displayed visualized representation to a user. The user executes one of a trade or research based upon the displayed visualized representation.

A method includes receiving and storing data related to a first entity and entities related to the first entity to generate relationship data. The method further includes processing the relationship data in order to remove data from the relationship data that is less relevant to a relationship between a pair of entities to generate filtered data. The filtered data is received and weights are applied to relationships between the entities to generate weighted data. The method further includes receiving the weighted data and generating a visualized representation of the related entities and the relationship between the entities. The visualized representation is received and a displayed visualized representation is generated. The displayed visualized representation includes the first entity and the related entities and the relationship therebetween, wherein the relationship is displayed by connections between the entities. The visualized representation is displayed to a user, and the user executes one of a trade or research based upon the displayed visualized representation.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example equity network system according to the principals of the present disclosure;

FIG. 2 is an example of a visual representation of weighted relationships between a selected security and other securities based on the industry sector in accordance with the principles of the present disclosure;

FIG. 3 is a graph indicating the weighting between a selected securities and various industry sectors;

FIG. 4 is another example of a visual representation of weighted relationships between a selected security and other securities based on the industry sector in accordance with the principles of the present disclosure;

FIG. 5 is an expanded view of a portion of FIG. 4; and

FIG. 6 is a flowchart of an example implementation of the equity network system.

In the drawings, reference numbers may be reused to identify similar and/or identical elements.

### DETAILED DESCRIPTION

The Global Industry Classification Standard (“GICS”) was developed by Morgan Stanley Capital International (“MSCI”) and Standard & Poors (“S&P”) as an industry taxonomy that groups all major public companies into 11 sectors, 24 industry groups, 69 industries, and 158 sub-industries. The GICS is used for grouping financial market indexes and has further been revised to address changes in industry sectors. The GICS, however, does not fully describe diverse entities. For just one example, a company like Amazon is an online retailer, technology developer, leading provider of web services, device manufacturer, grocery store, and onward. Such diversity presents challenges to grouping Amazon with its competitors to form an accurate index. According to GICS, Amazon is grouped in the Consumer Discretionary sector along with McDonald's, Home Depot, NIKE, Starbuck's, and Lowes. Advisors and clients, however, may not view the other companies in the Consumer Discretionary sector as peer companies to Amazon. Taking the example of Amazon further, when attempting to diversify from a company like Amazon, advisors and clients must consider whether any portfolio adjustments provide the intended diversification. For example, client and advisors may question whether Amazon is truly diverse from companies like Tesla, American Airlines, or Progressive Insurance.

According to various embodiments, the present disclosure analyzes news content to associate entities and find relationships that current classification techniques miss or do not understand. Once connections between entities have been identified, clients are provided with cluster webs or graphs that show related companies and the strength of those relationships. This information can help investors, whether clients or advisors, recognize how apparently diverse entities depend on one another and to make decisions based upon those relationships.

According to various embodiments, the equity network described herein defines cluster webs or web graphs using the GICS standard and an analysis of news content. In various embodiments, the GICS classification system is weighted by 10% and relationship between companies determined by analysis of news content is weighted by 90%. The news analysis provides more clarity regarding how companies relate to one another. By way of non-limiting example, a news item about Amazon's web services may mention Microsoft's Azure platform, Google Cloud, or IBM. By way of another non-limiting example, a news item about Whole Foods may mention Publix, Trader Joes, or Kroger. These news stories and articles help provide the true cluster web for diverse companies and establish relationships.

In various embodiments, various systems analyze news items and identify companies for use in educational content and content provided to clients or investors based on a portfolio of interest. After analyzing news items to build the equity network described herein, a cluster web can be dynamically updated based on newer stories. Newer stories can be weighted more heavily and we can also consider price movement to indicate whether an association between a company of interest and a news item is positive or negative.

In various embodiments, various company reports can be analyzed to determine entities that a company determines to be its key competitors. This information would then be added into the equity network of the present disclosure to determine more direct links between companies. In various other embodiments, information includes a company's suppliers and consumer sentiment about that company can be input to the equity network.

In various embodiments, the equity network of the present disclosure can be displayed to the user as a web of connected circles. In various embodiments, the color of the circles displays the GICS sector of the company and the thickness of the lines show how strongly the companies are connected to one another. In various embodiments, only two or three relationships are shown on the cluster web because the more distant the relationship, the weaker the relationship between the item and the company. In various embodiments, the cluster web view displays not only the peers of a particular company, but also the diversity and unrelatedness between companies. By way of non-limiting example, two companies that otherwise appear diverse may both have a strong connection to a third party service provider. A user could also determine if a company stands out from its peers with respect to its relationships to other companies.

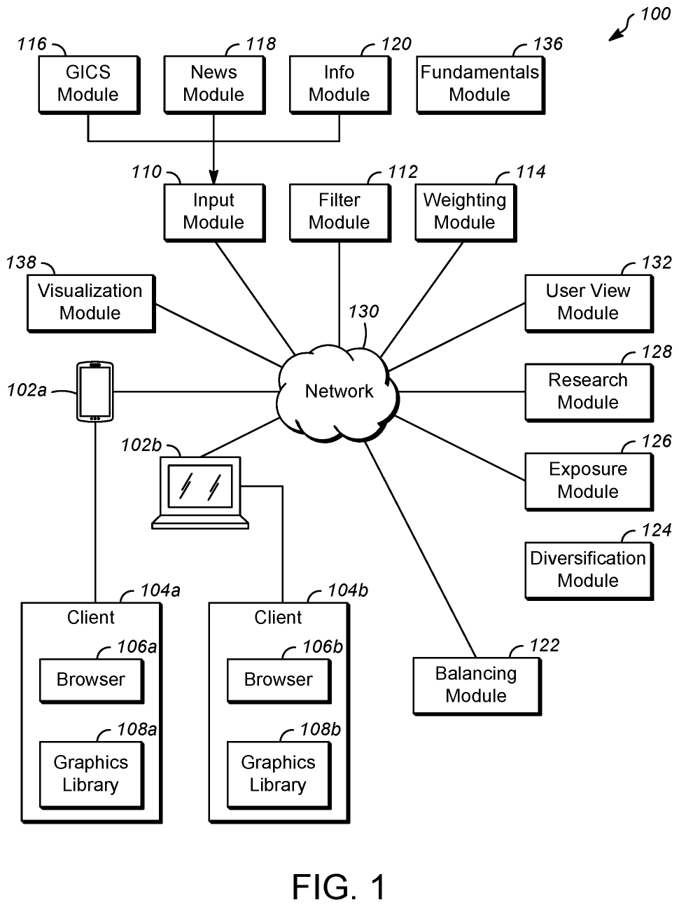

FIG. 1 depicts an example equity network system 100. Equity network system 100 includes user devices or input devices 102a, 102b, collectively referred to as input device 102, which may be portable devices such as a smart phone or tablet 102a or a computer or laptop 102b. Each input device implements a respective client 104a, 104b, collectively referred to as client 104. Each client 104 includes a respective browser 106a, 106b and a respective graphic visualization physics library 108a, 108b, as will be described in greater detail herein. Throughout the description of FIG. 1, network 130 interconnects the various devices, modules, and client described therein. In various embodiments, the elements of equity network system 100 communicate via network 130. The various elements of equity network system 100 communicate with network 130 either directly, or connect through an intermediate element, including via a cloud, Internet, or intranet

Equity network system 100 includes input subsystem module 110, filter subsystem module 112, and weighting subsystem module 114. Input subsystem module 110 receives input from GICS subsystem module 116, news subsystem module 118, info subsystem module 120, and fundamentals subsystem module 136. GICS subsystem module 116 provides data to input subsystem module 110 in accordance with the GICS subsystem, which includes the sectors, groups, industries, and sub-industries as described above. News subsystem module 118 provides input including news items which have been aggregated and digested to provide insights, education, potential trade analysis, and a dedicated trade desk to the client or advisor. The digested news items are organized to facilitate trading analysis. Info subsystem module 120 provides data to input subsystem module 110 including various information items, such as 10K/10Q filing and earnings reports of various companies and other publicly available reports, social media mentions and trends, supply chain information, and various other structured or unstructured data sets. Fundamentals subsystem module 136 provides data to input subsystem module 110 including various information items related to financial metrics about a company, including, but not limited to earnings, earnings before interest and taxes (EBIT), economic value added (EVA), Berry ratio, contribution margin, liquidity ratio, interest cover, days in accounts receivables, net cash flow, gross profit margin, and transactions error rate. In various embodiments each of the fundamentals subsystem module 136 data items can be implemented in a separate subsystem module or combined into fundamentals subsystem module as shown in FIG. 1. In various embodiments, each of the fundamentals subsystem module 136 items can be grouped based on market capitalization, such as small capitalization, medium capitalization, and large capitalization. In various embodiments, filter subsystem module 112 can be used to filter data received from one or any of GICS subsystem module 116, news subsystem module 118, and info subsystem module 120. Filter subsystem module 112, according to various embodiments, gives filter inputs determined to be less relevant or of lower quality in defining relationships between various companies or entities.

In various embodiments, equity network system 100 includes weighting subsystem module 114 and visualization subsystem module 138. Weighting subsystem module 114 receives data from input subsystem module 110 via network 130 and applies weighting to the various layers of data received therefrom. The weighting enables defining the relationship between a company or entity of interest and related companies or entities of interest. In various embodiments, weighting subsystem module 114 generates data and defines the relationship parameters between a company or entity of interest and related companies or entities of interest.

In various embodiments, weighting subsystem module 114 outputs multiple layers of input data as weighted to visualization subsystem module 138. Visualization subsystem module 138 generates a graphical representation of each company or entity and related companies or entities. In various embodiments, as will be described in greater detail, each company or entity may be represented by a Stock symbol as may be assigned on the New York Stock Exchange (NYSE), the National Association of Securities Dealers Automated Quotations (NASDAQ), or any other exchange, so long as each entity may be identified by the particular symbol assigned thereto. Each company or entity may occupy a node or point on the cluster web or web graph.

In various embodiments, equity network system 100 includes user view subsystem module 132. User view subsystem module 132 enables a client or advisor to interrogate the output of visualization subsystem module 138. In various embodiments, user view subsystem module 132 may be implemented as part of client 104 or independent of client 104. In various embodiments, a client or advisor interrogates the output of visualization subsystem module 138 to the user input device 102, as will be described in greater detail herein.

In various embodiments, equity network system 100 includes balancing subsystem module 122, diversification subsystem module 124, exposure subsystem module 126, and research subsystem module 128. Each of balancing subsystem module 122, diversification subsystem module 124, exposure subsystem module 126, and research subsystem module 128 can be controlled via user input device 102 and respective client 104.

In a non-limiting example, balancing subsystem module 122 is configured to process cluster web output by visualization subsystem module 138 and determine if, by investigating the relationships between the companies in the cluster web, there is an imbalance between the various nodes or companies in the cluster web. Balancing subsystem module 122 addresses the imbalance by recommending trades to the client or the advisor in order to provide a more balanced portfolio so that the portfolio is not overly reactive to a particular event affecting one or a particular few companies or nodes of the cluster web.

In a non-limiting example, diversification subsystem module 124 is configured to process cluster web output by visualization subsystem module 138 and determine if, by investigating the relationships between the companies in the cluster web, opportunities exist for diversification between the companies on the cluster web. In various embodiments, if the cluster web indicates that a portfolio is not sufficiently diversified, the client or advisor activates the diversification subsystem module 124 in order to suggest trades in order to better diversify the companies represented on the cluster web output by visualization subsystem module 138.

In a non-limiting example, exposure subsystem module 126 is configured to process cluster web output by visualization subsystem module 138 and determine if, by investigating the relationships between the companies and the relationships in the cluster web, the client or advisor is at risk of being overexposed to certain areas or events that might occur and impact the cluster web. Exposure subsystem module 126 addresses the exposure by recommending trades to the client or the advisor in order to provide a portfolio less exposed to a particular area of the market.

In a non-limiting example, research subsystem module 128 is configured to process cluster web output by visualization subsystem module 138 and assist the client or advisor in conducting market research and investigation. In various embodiments, as will be described in greater detail herein, the client or advisor may drill into particular areas of the cluster web in order to obtain particular information or to obtain greater detail on a particular aspect in the cluster web.

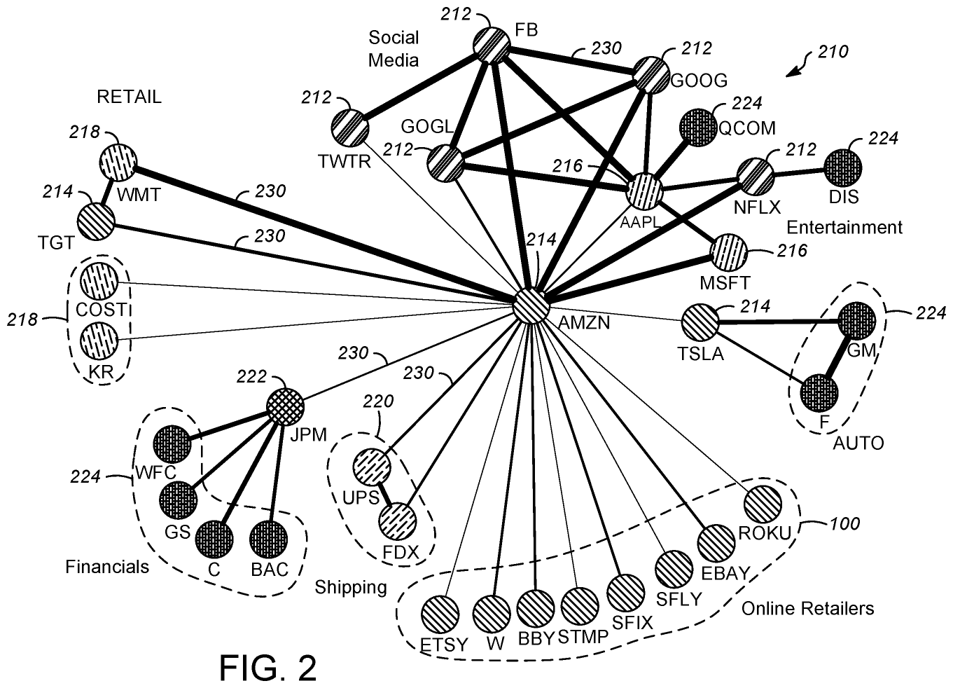

FIG. 2 depicts a cluster web or graph 210 arranged in accordance with the principles of the present disclosure. Cluster web 210 of FIG. 2 is intended to show example relationships with respect to Amazon (AMZN). Cluster web 210 includes a number of nodes or companies connected to AMZN via connectors 230. The companies in FIG. 2 are organized generally by business types, including Online Retailers, Shipping, Financials, Retail, Social Media, Entertainment, and Automotive. As can be seen between Social Media and Entertainment, some companies do not fit neatly into a particular sector and could be situated between sectors. In other embodiments organization of the cluster web can be according to various groupings, including business sectors, line thickness, and color of each node of the cluster web.

As shown in FIG. 2, connectors 230 connect various nodes, such as, for example, AMZN and Ebay (EBAY), AMZN and Walmart (WMT), and AMZN and Tesla (TSLA). Connectors 230 can indicate various relatedness parameters between two connected nodes in accordance with one or a plurality of thickness, color, length, directionality, and texture of connectors 230, defined as connector parameters. In various embodiments, a connector may show multiple relations. For example, line thickness may indicate one relationship property, while color or length of a connector may indicate different relationship properties. A relatedness parameter can include sales price, sales volume, social media mentions, business sectors, or any of the other data items mentioned above, or some combination thereof. In various embodiments, data received from news subsystem module 118 of FIG. 1 may provide an initial configuration for one or a number of thickness, color, length, directionality, and texture of connectors 230. In various other embodiments, the various connector parameters can the modified in accordance with the GICS subsystem module 116 and info subsystem module 120.

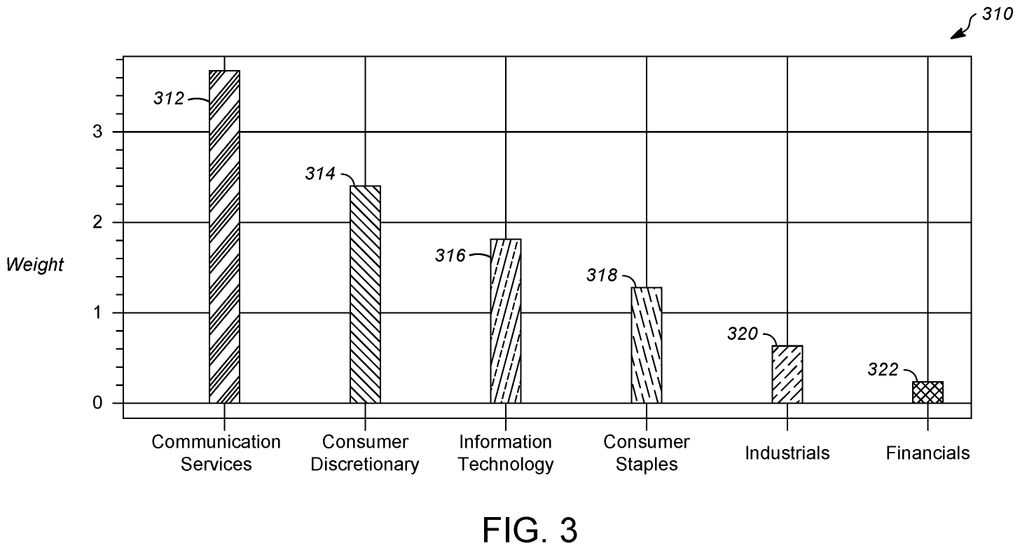

FIG. 3 is a chart depicting GICS sector graph 310 showing sectors arranged along a horizontal axis and weighting of those sectors arranged along a vertical axis. In FIG. 3, communication services sector 312 is most heavily weighted of all sectors. Communication services sector 312 maps onto nodes 212 of FIG. 2. In various embodiments a mapping can be indicated by the color of the sector in FIG. 3 and the color of the nodes in FIG. 2. In various embodiments, communication services sector 312 of FIG. 3 maps onto nodes 212 of FIG. 2, and such mapping can also be indicated, by way of example, using a common color. Consumer discretionary sector 314 is less heavily weighted than communication services sector 312. Consumer discretionary sector 314 maps onto nodes 214 of FIG. 2. In various embodiments, consumer discretionary sector 314 of FIG. 3 maps onto nodes 214 of FIG. 2, and such mapping can also be indicated, by way of example, using a common color. Information technology sector 316 is less heavily weighted than consumer discretionary sector 314. Information technology sector 316 maps onto nodes 216 of FIG. 2. In various embodiments, information technology sector 316 of FIG. 3 maps onto nodes 216 of FIG. 2, and such mapping can also be indicated, by way of example, using a common color. Consumer staples sector 318 is less heavily weighted than information technology sector 316. Consumer staples sector 318 maps onto nodes 218 of FIG. 2. In various embodiments, consumer staples sector 318 of FIG. 3 maps onto nodes 218 of FIG. 2, and such mapping can also be indicated, by way of example, using a common color. Industrials sector 320 is less heavily weighted than consumer staples sector 318. Industrials sector 320 maps onto nodes 220 of FIG. 2. In various embodiments, industrials sector 320 of FIG. 3 maps onto nodes 220 of FIG. 2, and such mapping can also be indicated, by way of example, using a common color. Financial sector 322 maps onto nodes 222 of FIG. 2. In various embodiments, financials sector 322 of FIG. 3 maps onto nodes 222 of FIG. 2, and such mapping can also be indicated, by way of example, using a common color. FIG. 2 also indicates secondary nodes 224. Secondary nodes 224 represent secondary connections with the primary company, AMZN in the example of FIG. 1. Secondary nodes 224 may be represented in FIG. 2 using a common color. Secondary nodes 224 do not need to belong to the same sector or business type.

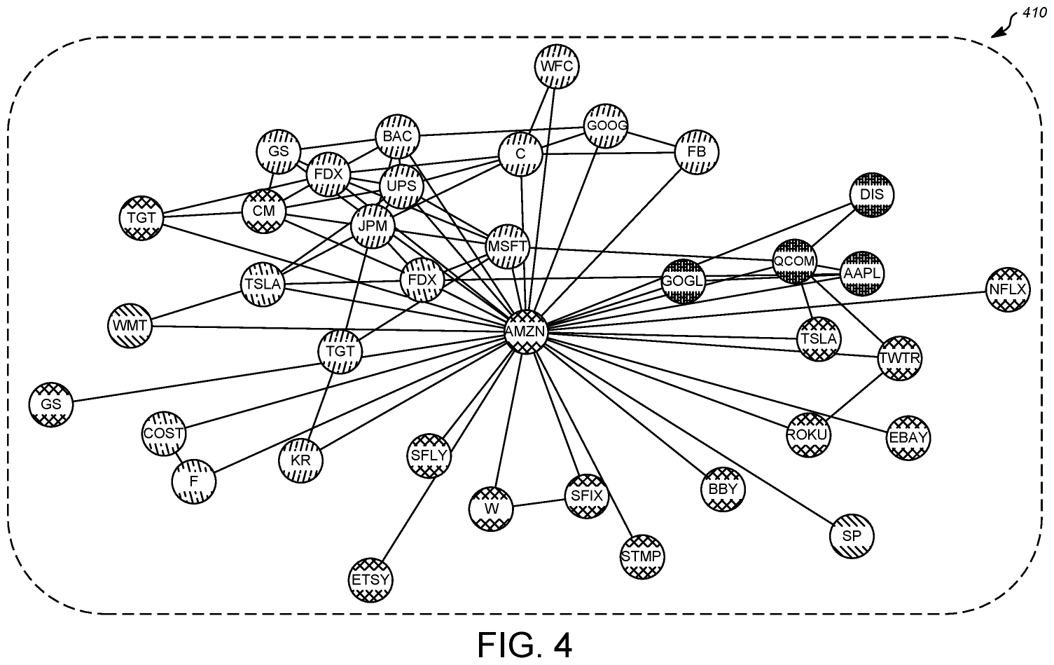

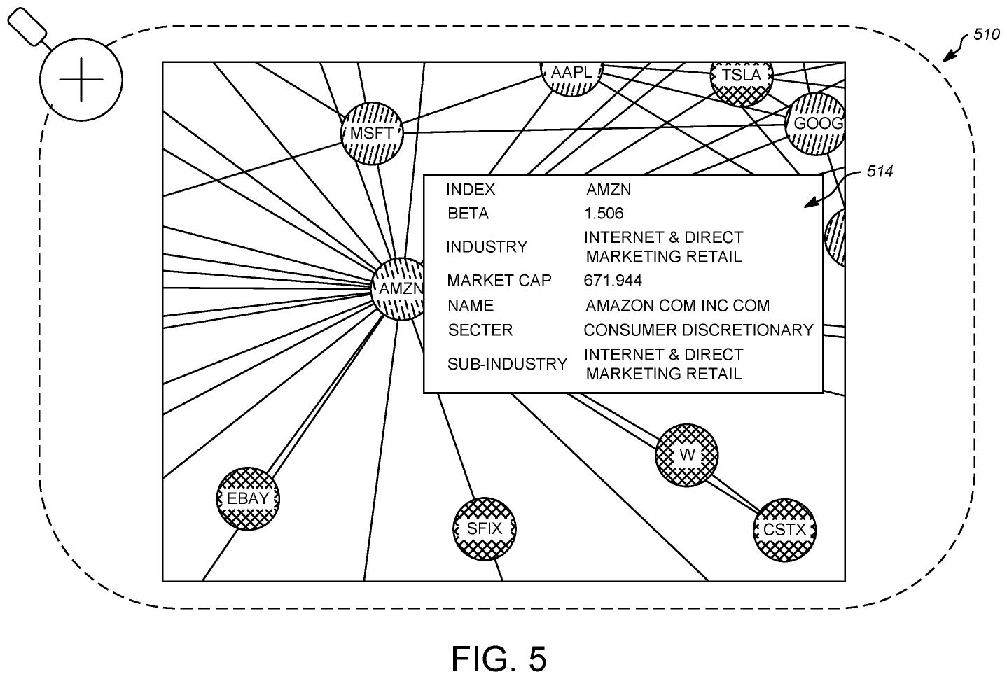

FIG. 4. depicts an example cluster web 410. Cluster web 410 may be configured similarly to the cluster web described in FIGS. 2 and 3. In particular, cluster web 410 may include various nodes that represent various companies. The nodes may be related by business sectors and may be organized visually with respect to business type. Connectors between the nodes may represent various relatedness parameters between two connected nodes in accordance with one or a number of thickness, color, length, directionality, and texture of connectors, defined as connector parameters. FIG. 5 depicts a cluster web 510 that is an expanded view a portion of cluster web 410 of FIG. 4. In various embodiments, a client or advisor may drill into a cluster web, such as cluster web 410 of FIG. 4, to expand a view and obtain additional information. In various embodiments, a client or advisor can drill into a note for a connector in order to obtain a cluster web 510 representing an expanded view of a portion of cluster web 410, or may drill into a connector to review the data used to define the parameters of the connector. As shown in FIG. 5, drilling into a portion of cluster web 410 of FIG. 4 displays information block 514. Information block 614 may be displayed upon creation of cluster web 510 or may be displayed when the client or advisor positions a pointing device on an element of cluster web 510. Control of the pointing device by the client or advisor may occur via one or both of user input device 102 and client 104.

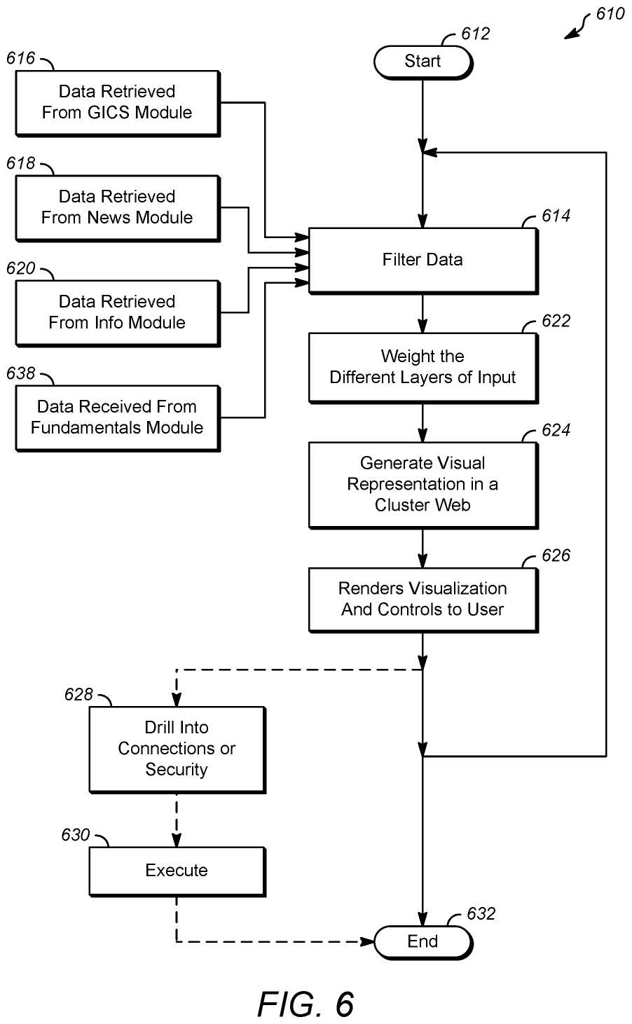

FIG. 6 depicts a flow chart 610 detailing one example of operation of the equity network system of FIGS. 1-5. Control begins at block 612 and proceeds to block 614. Block 614 receives data from blocks 616, 618, 620, and 638. Block 616 provides GICS data from a GICS module, such as GICS subsystem module 116 of FIG. 1, as described above. Block 618 provides data from a news subsystem module, such as news subsystem module 118 of FIG. 1, as described above. Block 620 provides data from an info subsystem module, such as info subsystem module 120 of FIG. 1, as described above. Block 638 provides data from an info subsystem module, such as info subsystem module 120 of FIG. 1, as described above. Block 614 filters data from one, two, or all of the data input streams provided by blocks 616, 618, 620, 638. In various embodiments, filtering occurring at block 614 includes limiting data determined to be of lesser value to the process of establishing connections between companies.

Block 622 determines the weight of the different layers of input. With reference to FIG. 1, weighting subsystem module 114 applies weights to different layers of input. In various embodiments, a weighting chart as shown in FIG. 3 provides a basis for weighting the different layers of input in accordance with particular news received from news subsystem module 118, or other selected weighting parameters. The weights are applied, and block 624 generates a visual representation of the relationships between a selected company and related companies in the form of a cluster web, such as are shown at FIGS. 2-5. In various embodiments, the weights can define a numerical index and the relatedness parameter of a connector can be multiplied by the numerical index. In various other embodiments, the weighting can be a complex transfer function that considers multiple inputs to generate one or more outputs that define respective one or more relatedness parameters.

At block 626, the visual representation generated at block 624 is input to block 626. Block 626 renders a visualization to a respective client device, such as client 104a, 104b, and is returned for display on respective user devices or input devices 102a, 102b. At block 626, the client 104a, 104b renders visualization and controls for manipulation by a user interface of the equity network system such as user devices or input devices 102a, 102b.

In various embodiments, control proceeds to block 628 which enables a client or advisor to drill into various nodes of the cluster web in order to consider one or more of portfolio balance, diversification, exposure, or to perform additional research, as shown at respective blocks 122, 124, 126, and 128 of FIG. 1. At block 630 the client or advisor can execute trades to adjust one or more of portfolio balance, diversification, and exposure, as described above with respect to FIG. 1. Control ends at block 632. Blocks 628 and 630 represent optional steps in flow chart 610. Control ends at block 632.

In various embodiments the equity network described herein can be used in combination with an investor movement index or a content intelligence platform to enhance client and advisor choices. This provides clients the opportunity to better understand the relationships between companies and improves their experience.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
an input subsystem module configured to receive and store data related to a first entity and entities related to the first entity, wherein the input subsystem module is configured to generate relationship data;
a filter subsystem module configured to process the relationship data, the filter subsystem module also configured to remove data from the relationship data that is less relevant to a relationship between a pair of entities, the filter subsystem module generates filtered data;
a weighting subsystem module configured to receive the filtered data and apply weights to relationships between the entities, the weighting subsystem module also configured to generate weighted data;
a visualization subsystem module configured to receive the weighted data and generate a visualized representation of the related entities and the relationship between the entities;
a server configured to receive the visualized representation and generate a displayed visualized representation, wherein the displayed visualized representation includes the first entity and the related entities and the relationship therebetween, wherein the relationship is displayed by connections between the entities; and
a client device configured to view the displayed visualized representation to a user, wherein the client device is configured to receive input from a user requesting execution of one of a trade or research based upon the displayed visualized representation.

2. The system of claim 1 further comprising a balancing subsystem module configured to trade at least one of the entities in order to balance the relationship between the entities.

3. The system of claim 1 further comprising a diversification subsystem module configured to trade at least one of the entities in order to diversify the relationship between the entities.

4. The system of claim 1 further comprising an exposure subsystem module configured to trade at least one of the entities in order to reduce exposure of at least one entity with respect to an effect of a relationship between a pair of entities.

5. The system of claim 1 wherein the displayed visualized representation is a cluster web including a plurality of nodes, and each node of the plurality of nodes corresponds to a respective entity.

6. The system of claim 1 wherein:
the connections between the entities further comprises a line between a first selected entity and a second selected entity, and
the line interconnects a first node corresponding to the first selected entity and a second node corresponding to the second selected entity.

7. The system of claim 6 wherein the line includes at least one characteristic, and the at least one characteristic indicates a strength of at least one respective relatedness parameter.

8. The system of claim 7 wherein at least one characteristic includes thickness, length, color, directionality, or texture.

9. The system of claim 7 wherein the relatedness parameter includes at least one of sales price, sales volume, social media mentions, or business sectors.

10. The system of claim 1 wherein the input subsystem module is configured to receive data from at least one of GICS data, news data, and other data.

11. The system of claim 1 wherein the weighting subsystem module is configured to weight the relationships between the entities in accordance with GICS data.

12. A method comprising:
receiving and storing data related to a first entity and entities related to the first entity to generate relationship data;
processing the relationship data in order to remove data from the relationship data that is less relevant to a relationship between a pair of entities to generate filtered data;
receiving the filtered data and applying weights to relationships between the entities to generate weighted data;
receiving the weighted data and generating a visualized representation of the related entities and the relationship between the entities;
receiving the visualized representation and generating a displayed visualized representation, the displayed visualized representation including the first entity and the related entities and the relationship therebetween, wherein the relationship is displayed by connections between the entities; and
displaying the visualized representation to a user; and
executing one of a trade or research based upon the displayed visualized representation from the user.

13. The method of claim 12 further comprising the user trading at least one of the entities in order to balance the relationship between the entities.

14. The method of claim 12 further trading at least one of the entities in order to diversify the relationship between the entities.

15. The method of claim 12 further comprising trading at least one of the entities in order to reduce exposure of at least one entity with respect to an effect of a relationship between a pair of entities.

16. The method of claim 12 wherein the displayed visualized representation is a cluster web including a plurality of nodes, and each node of the plurality of nodes corresponds to a respective entity.

17. The method of claim 12 wherein the connections between the entities further comprises a line between a first selected entity and a second selected entity, and the line interconnects a first node corresponding to the first selected entity and a second node corresponding to the second selected entity.

18. The method of claim 17 wherein the line includes at least one characteristic, and the at least one characteristic indicates a strength of at least one respective relatedness parameter.

19. The method of claim 18 wherein at least one characteristic includes thickness, length, color, directionality, or texture.

20. The method of claim 18 wherein the relatedness parameter includes at least one of sales price, sales volume, social media mentions, or business sectors.

21. The method of claim 12 wherein the received data includes data from at least one of GICS data, news data, and other data.

22. The method of claim 12 wherein the applied weights are determined in accordance with GICS data.
